(19) United States
(12) Patent Application Publication
(10) Pub. No.: US 2011/0122811 A1
(43) Pub. Date: May 26, 2011

(54) Codebook restructure, differential encoding/decoding and scheduling

(75) Inventors: Jun Yuan, Ottawa (CA); Mo-Han Fong, Ottawa (CA); Hosein Nikopourdeilami, Stittsville (CA)

(73) Assignee: Nortel Networks Limited

(21) Appl. No.: 12/801,979

(22) Filed: Jul. 6, 2010

Related U.S. Application Data
(63) Continuation-in-part of application No. 12/806,184, filed on Jul. 6, 2009.
(60) Provisional application No. 61/078,491, filed on Jul. 7, 2008.

(51) Int. Cl. H04W 40/00

(52) U.S. Cl. 370/328

(57) ABSTRACT

A method and apparatus for feedback of channel information characterizing a wireless transmission between a base station and a mobile station. The method involves, at the base station, locating in a codebook of predetermined channel responses a predetermined channel response identified by: a primary identifier identifying a cluster associated with a channel response generated by a mobile station; and a differential identifier identifying channel response member within the cluster identified by the primary identifier. The predetermined channel responses are grouped in a plurality of clusters in accordance with a correlation criterion, each cluster including a plurality of predetermined channel response members. The method also involves generating a control signal for controlling transmissions to the mobile station in accordance with the located predetermined channel response. A method and apparatus for feedback of channel information characterizing a wireless transmission between a mobile station and a base station are also disclosed.

### CROSS-REFERENCES TO RELATED APPLICATIONS

This application claims the benefit of U.S. provisional patent application 61/223,188, filed on Jul. 6, 2009, which is hereby incorporated by reference in its entirety.

This application is a continuation-in-part of the non-provisional application (serial number to be determined) resulting from conversion under 37 C.F.R. §1.53(c)(3) of U.S. provisional patent application 61/223,188, filed on Jul. 6, 2009, which claims the benefit of U.S. provisional patent application 61/078,491 filed on Jul. 7, 2008.

### BACKGROUND OF THE INVENTION

1. Field of Invention

This invention relates generally to wireless communications between a base station and a mobile station and more particularly to feedback of channel information characterizing a wireless transmission between the base station and the mobile station.

2. Description of Related Art

In wireless communications between a base station and a mobile station over a communications channel, system performance may be improved if the base station is provided feedback information characterizing the communications channel. For example, in a communication system that employs multiple antennas at either the base station and/or the mobile station, the base station may make changes to transmissions occurring on each antenna in response to the feedback information. Accordingly, the mobile station may perform channel estimation on received signals and may feed back channel characterization information to the base station. One problem is that for best system performance, the feedback of channel responses may be a large communications overhead. Since uplink bandwidth between the mobile station and the base station is limited, such additional transmission of data represents a feedback overhead. There remains a need for methods and apparatus that reduce such system overheads.

### SUMMARY OF THE INVENTION

In accordance with one aspect of the invention there is provided a method for feedback of channel information characterizing a wireless transmission between a base station and a mobile station over a communications channel. The method involves receiving a primary identifier identifying a cluster associated with a channel response generated by a mobile station, receiving a differential identifier identifying channel response member within the cluster identified by the primary identifier, and locating in a codebook of predetermined channel responses a predetermined channel response identified by the primary identifier and the differential identifier. The predetermined channel responses in the codebook are grouped in a plurality of clusters in accordance with a correlation criterion, each cluster including a plurality of predetermined channel response members. The method also involves generating a control signal for controlling transmissions to the mobile station in accordance with the located predetermined channel response.

Receiving the primary identifier may involve causing the mobile station to transmit the primary identifier during a first time period and receiving the differential identifier may involve causing the mobile station to transmit the differential identifier during a second time period, the second time period occurring subsequent to the first time period.

Causing the mobile station to transmit the primary identifier during the first time period may involve causing the mobile station to transmit the differential identifier at a plurality of first time periods separated in time by a first predetermined time interval.

Causing the mobile station to transmit the differential identifier may involve causing the mobile station to transmit a differential identifier at a plurality of second time periods separated in time by a second predetermined time interval, the second predetermined time interval being less than the first predetermined time interval.

Causing the mobile station to transmit the differential identifier may involve causing the mobile station to transmit the differential identifier during a plurality of second time periods separated in time by a predetermined time interval between successive first time periods.

Causing the mobile station to transmit the differential identifier may involve causing the mobile station to transmit the differential identifier when a criterion for transmission of the differential identifier is met.

The codebook may include N1 clusters, each cluster may include N2 members and causing the mobile station to transmit the primary identifier and the differential identifier may involve causing the mobile station to transmit a primary identifier and a differential identifier having the same number of bits:

The method may involve periodically transmitting the codebook to the mobile station.

Each cluster in the codebook may be associated with a primary predetermined channel response and each member in the cluster may define respective differences from the associated primary predetermined channel response.

In accordance with another aspect of the invention there is provided a method for feedback of channel information characterizing a wireless transmission between a base station and a mobile station over a communications channel. The method involves determining a channel response for at least one carrier frequency received at the mobile station, and locating in a codebook of predetermined channel responses a predetermined channel response that is a closest match to the determined channel response. The predetermined Channel responses in the codebook are grouped in a plurality of clusters in accordance with a correlation criterion, each cluster including a plurality of predetermined channel response members. The method also involves causing the mobile station to transmit a primary identifier identifying a cluster associated with the located predetermined channel response to the base station, and causing the mobile station to transmit a differential identifier identifying the located predetermined channel response member within the cluster identified by the primary identifier.

Determining may involve determining the channel response during successive time periods and locating may involve for each successive time period, locating a predetermined channel response that may be a closest match to the determined channel response and causing the mobile station to transmit the primary identifier may involve causing the mobile station to transmit the primary identifier during a first time period, and causing the mobile station to transmit the differential identifier may involve causing the mobile station to transmit the differential identifier during a second time period, the second time period occurring subsequent to the first time period.

Causing the mobile station to transmit the primary identifier may involve causing the mobile* station to transmit the differential identifier at a plurality of first time periods separated in time by a first predetermined time interval.

Causing the mobile station to transmit the differential identifier may involve causing the mobile station to transmit a differential identifier at a plurality of second time periods separated in time by a second predetermined time interval, the second predetermined time, interval being less than the first predetermined time interval.

Causing the mobile station to transmit the differential identifier may involve causing the mobile station to transmit the differential identifier during a plurality of second time periods separated in time by a predetermined time interval between successive first time periods.

Causing the mobile station to transmit the differential identifier may involve causing the mobile station to transmit the differential identifier when a criterion for transmission of the differential identifier is met.

The criterion for transmission of the differential identifier may include a demand from the base station.

The criterion for transmission of the differential identifier may include a determination made by the base station.

The method may involve causing the mobile station to transmit a new primary identifier to the base station when a predetermined channel response that is the closest match to the determined channel response is not associated with the cluster identified by the primary identifier transmitted to the base station in a previous first time period.

The codebook may include N1 clusters, each cluster may include N2 members and causing the mobile station to transmit the primary identifier and the differential identifier may involve causing the mobile station to transmit a primary identifier and a differential identifier having the same number of bits.

The method may involve periodically causing the mobile station to receive the codebook from the base station.

Each cluster may be associated with a primary predetermined channel response and each member in the cluster may define respective differences from the associated primary predetermined channel response.

In accordance with another aspect of the invention there is provided a base station apparatus. The apparatus includes a receiver for receiving a wireless transmission from a mobile station over a communications channel, a processor circuit in communication with the receiver, the processor circuit having a computer readable medium for storing a codebook of predetermined channel responses grouped in a plurality of clusters in accordance with a correlation criterion. Each cluster includes a plurality of predetermined channel response members. The processor circuit is operably configured to receive a primary identifier identifying a cluster associated with a channel response generated by a mobile station, and to receive a differential identifier identifying channel response member within the cluster identified by the primary identifier. The processor circuit is also operably configured to locate in the codebook a predetermined channel response identified by the cluster and the differential identifier, and to generate a control signal for controlling transmissions to the mobile station in accordance with the located predetermined channel response.

The processor circuit may be operably configured to cause the mobile station to transmit the primary identifier during a first time period and to cause the mobile station to transmit the differential identifier during a second time period, the second time period occurring subsequent to the first time period.

The processor circuit may be operably configured to cause the mobile station to transmit the differential identifier at a plurality of first time periods separated in time by a first predetermined time interval.

The processor circuit may be operably configured to cause the mobile station to transmit a differential identifier at a plurality of second time periods separated in time by a second predetermined time interval, the second predetermined time interval being less than the first predetermined time interval.

The processor circuit may be operably configured to cause the mobile station to transmit the differential identifier during a plurality of second time periods separated in time by a predetermined time interval between successive first time periods.

The processor circuit may be operably configured to cause the mobile station to transmit the differential identifier when a criterion for transmission of the differential identifier is met.

The codebook may include N1 clusters, each cluster may include N2 members and the processor circuit may be operably configured to cause the mobile station to transmit a primary identifier and a differential identifier having the same number of bits.

The processor circuit may be operably configured to periodically transmit the codebook to the mobile station.

Each cluster in the codebook may be associated with a primary predetermined channel response and each member in the cluster defines respective differences from the associated primary predetermined channel response.

In accordance with another aspect of the invention there is provided a mobile station apparatus. The apparatus includes a receiver for receiving a wireless transmission from a base station over a communications channel, a processor circuit in communication with the receiver, the processor circuit having a computer readable medium for storing a codebook of predetermined channel responses grouped in a plurality of clusters in accordance with a correlation criterion. Each cluster includes a plurality of predetermined channel response members. The processor circuit is operably configured to determine a channel response for at least one carrier frequency received at the receiver, and to locate in the codebook a predetermined channel response that is a closest match to the determined channel response. The processor circuit is also operably configured to transmit a primary identifier identifying a cluster associated with the located predetermined channel response to the base station, and to transmit a differential identifier identifying the located predetermined channel response member within the cluster identified by the primary identifier.

The processor circuit may be operably configured to determine the channel response during successive time periods and for each successive time period, to locate a predetermined channel response that is a closest match to the determined channel response and the processor circuit may be operably configured to transmit the primary identifier during a first time period, and to transmit the differential identifier during a second time period, the second time period occurring subsequent to the first time period.

The processor circuit may be operably configured to transmit the differential identifier at a plurality of first time periods separated in time by a first predetermined time interval.

The processor circuit may be operably configured to transmit the differential identifier at a plurality of second time periods separated in time by a second predetermined time interval, the second predetermined time interval being less than the first predetermined time interval.

The processor circuit may be operably configured to transmit the differential identifier during a plurality of second time periods separated in time by a predetermined time interval between successive first time periods.

The processor circuit may be operably configured to transmit the differential identifier when a criterion for transmission of the differential identifier is met.

The criterion for transmission of the differential identifier may include a demand from the base station.

The criterion for transmission of the differential identifier may include a determination made by the base station.

The processor circuit may be operably configured to transmit a new primary identifier to the base station when a predetermined channel response that is the closest match to the determined channel response is not associated with the cluster identified by the primary identifier transmitted to the base station in a previous first time period.

The codebook may include N1 clusters, each cluster may include N2 members and the processor circuit may be operably configured to transmit a primary identifier and a differential identifier having the same number of bits.

The processor circuit may be operably configured to periodically receive the codebook from the base station.

Each cluster may be associated with a primary predetermined channel response and each member in the cluster may define respective differences from the associated primary predetermined channel response.

In accordance with another aspect of the invention there is provided a codebook data structure encoded on a computer readable medium for characterizing a wireless transmission between a base station and a mobile station over a communications channel. The data structure includes a plurality of predetermined channel responses grouped in a plurality of clusters in accordance with a correlation criterion, each cluster including a plurality of predetermined channel response members.

Each cluster may be associated with a primary predetermined channel response and each member in the cluster may define respective differences from the associated primary predetermined channel response.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a block diagram of a generic cellular communication system in which aspects of the present invention may be implemented;

FIG. 2 is a block diagram of a base station depicted in FIG. 1;

FIG. 3 is a block diagram of a wireless terminal depicted in FIG. 1;

FIG. 4 is a block diagram of an example relay station depicted in FIG. 1;

FIG. 5 is a block diagram of a logical breakdown of an example OFDM transmitter of the base station shown in FIG. 2;

FIG. 6 is a block diagram of a logical breakdown of an example OFDM receiver of the wireless terminal shown in FIG. 3;

FIG. 7 is a schematic diagram of a network architecture implemented by the cellular communication system shown in FIG. 1 and corresponds to FIG. 1 of IEEE 802.16m-081003r1;

FIG. 8 is a schematic diagram of an architecture of the Relay Station shown in FIG. 4 and corresponds to FIG. 2 of IEEE 802.16m-08/003r1;

FIG. 9 is a schematic representation of a System Reference Model of the cellular communication system shown in FIG. 1 and corresponds to FIG. 3 of IEEE 802.16m-08/003r1;

FIG. 10 is a schematic representation of a Protocol Structure in accordance with IEEE 802.16m and corresponds to FIG. 4 of IEEE 802.16m-08/003r1;

FIG. 11 is a Processing Flow diagram of a MS/BS Data Plane in accordance with IEEE 802.16m and corresponds to FIG. 5 of IEEE 802.16m-08/003r1;

FIG. 12 is a Processing Flow diagram of the MS/BS Control Plane in accordance with IEEE 802.16m and corresponds to FIG. 6 of IEEE 802.16m-081003r1; and

FIG. 13 is a schematic representation of a Generic protocol architecture to support a multicarrier system and corresponds to FIG. 7 of IEEE 802.16m-081003r1.

FIG. 14 is a representation of a frequency spectrum transmitted by antennas of the base station shown in FIG. 5;

FIG. 15 is a tabular representation of a codebook used in the base station shown in FIG. 5 and the mobile station shown in FIG. 6;

FIG. 16 is a process executed by a processor circuit of the mobile station shown in FIG. 6 for performing feedback of a channel response;

FIG. 17 is a process executed by a processor circuit of the base station shown in FIG. 5 for receiving feedback of a channel response from the mobile station shown in FIG. 6;

FIG. 18 is a schematic representation of transmissions between the base station shown in FIG. 5 and first and second mobile stations such as shown in FIG. 6;

FIG. 19 is a tabular representation of an alternative embodiment of a codebook used in the base station shown in FIG. 5 and the mobile station shown in FIG. 6; and

FIG. 20 is a is a process executed by a processor circuit of the mobile station shown in FIG. 6 for performing feedback of a channel response to the base station shown in FIG. 5.

### DETAILED DESCRIPTION

Wireless System Overview

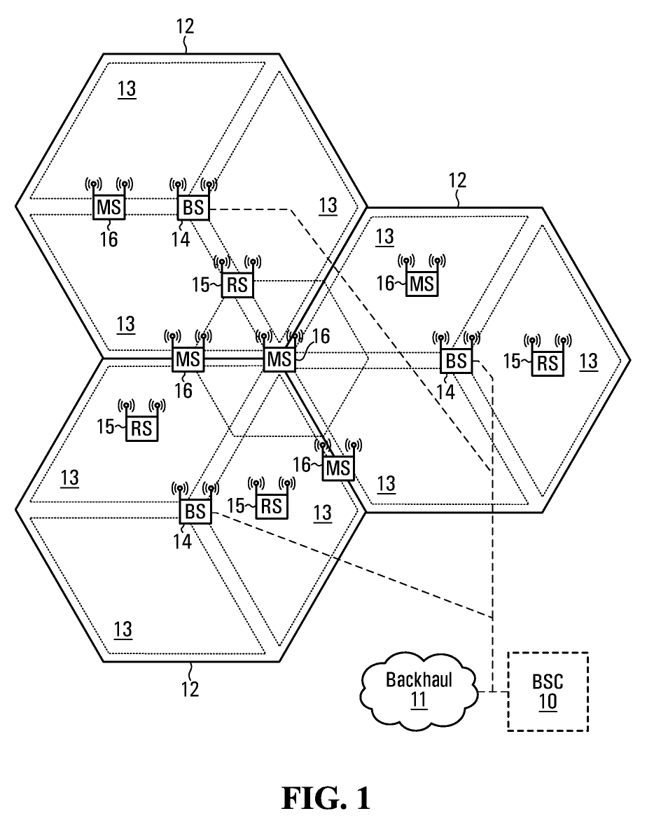

Referring to the drawings, FIG. 1 shows a base station controller (BSC) 10, which controls wireless communications within multiple cells 12, which cells are served by corresponding base stations (BS) 14. In some configurations, each cell is further divided into multiple sectors 13 or zones (not shown). In general, each base station 14 facilitates communications using Orthogonal Frequency-Division Multiplexing (OFDM) digital modulation scheme with mobile stations (MS) and/or wireless terminals 16, which are within the cell 12 associated with the corresponding base station 14.

Movement of the mobile stations 16 in relation to the base stations 14 results in significant fluctuation in channel conditions. As illustrated, the base stations 14 and the mobile stations 16 may include multiple antennas to provide spatial diversity for communications. In some configurations, relay stations 15 may assist in communications between the base stations 14 and the mobile stations 16. The mobile stations 16 can be handed off from any of the cells 12, the sectors 13, the zones (not shown), the base stations 14 or the relay stations 15, to another one of the cells 12, the sectors 13, the zones (not shown), the base stations 14 or the relay stations 15. In some configurations, the base stations 14 communicate with each other and with another network (such as a core network or the internet, both not shown) over a backhaul network 11. In some configurations, the base station controller 10 is not needed.

Base Station

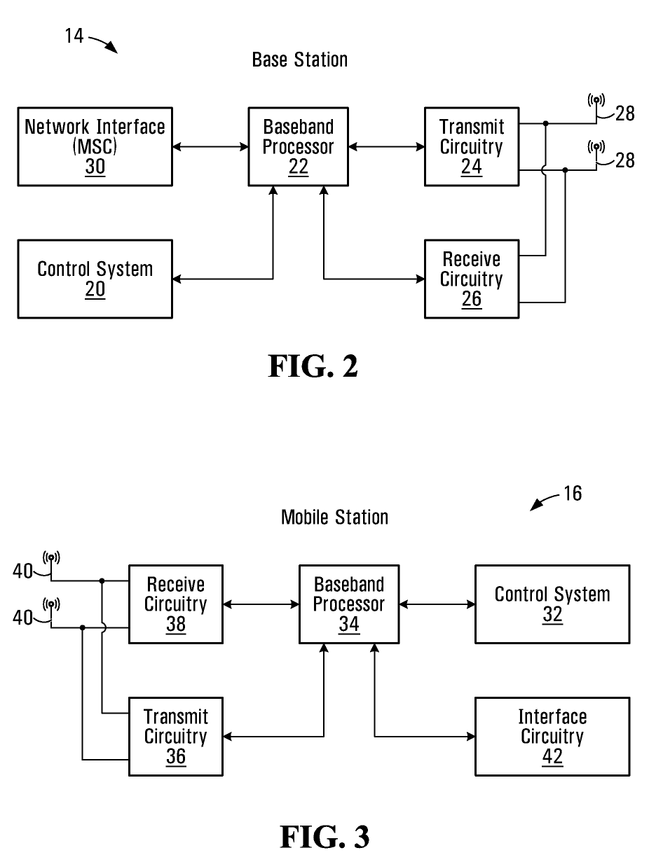

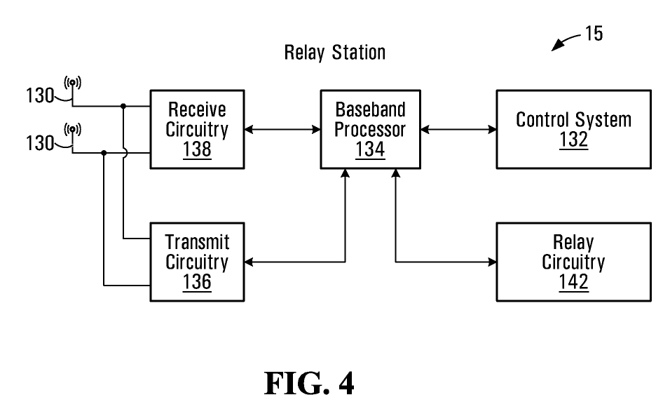

With reference to FIG. 2, an example of a base station 14 is illustrated. The base station 14 generally include a control system 20, a baseband processor 22, transmit circuitry 24, receive circuitry 26, multiple transmit antennas 28 and 29, and a network interface 30. The receive circuitry 26 receives radio frequency signals bearing information from one or more remote transmitters provided by the mobile stations 16 (illustrated in FIG. 3) and the relay stations 15 (illustrated in FIG. 4). A low noise amplifier and a filter (not shown) may cooperate to amplify and remove broadband interference from the received signal for processing. Downconversion and digitization circuitry (not shown) will then downconvert the filtered, received signal to an intermediate or baseband frequency signal, which is then digitized into one or more digital streams.

The baseband processor 22 processes the digitized streams to extract the information or data bits conveyed in the received signal. This processing typically comprises demodulation, decoding, and error correction operations. As such, the baseband processor 22 is generally implemented in one or more digital signal processors (DSPs) or application-specific integrated circuits (ASICs). The information is then sent across a wireless network via the network interface 30 or transmitted to another one of the mobile stations 16 serviced by the base station 14, either directly or with the assistance of one of the relay stations 15.

To perform transmitting functions, the baseband processor 22 receives digitized data, which may represent voice, data, or control information, from the network interface 30 under the control of the control system 20, and produces encoded data for transmission. The encoded data is output to the transmit circuitry 24, where it is modulated by one or more carrier signals having a desired transmit frequency or frequencies. A power amplifier (not shown) will amplify the modulated carrier signals to a level appropriate for transmission, and deliver the modulated carrier signals to the transmit antennas 28 and 29 through a matching network (not shown). Modulation and processing details are described in greater detail below.

Mobile Station

With reference to FIG. 3, an example of a mobile station 16 is illustrated. Similarly to the base stations 14, the mobile station 16 includes a control system 32, a baseband processor 34, transmit circuitry 36, receive circuitry 38, multiple receive antennas 40 and 41, and user interface circuitry 42. The receive circuitry 38 receives radio frequency signals bearing information from one or more of the base stations 14 and the relay stations 15. A low noise amplifier and a filter (not shown) may cooperate to amplify and remove broadband interference from the signal for processing. Downconversion and digitization circuitry (not shown) will then downconvert the filtered, received signal to an intermediate or baseband frequency signal, which is then digitized into one or more digital streams.

The baseband processor 34 processes the digitized streams to extract information or data bits conveyed in the signal. This processing typically comprises demodulation, decoding, and error correction operations. The baseband processor 34 is generally implemented in one or more digital signal processors (DSPs) and application specific integrated circuits (ASICs).

For transmission, the baseband processor 34 receives digitized data, which may represent voice, video, data, or control information, from the control system 32, which it encodes for transmission. The encoded data is output to the transmit circuitry 36, where it is used by a modulator to modulate one or more carrier signals at a desired transmit frequency or frequencies. A power amplifier (not shown) amplifies the modulated carrier signals to a level appropriate for transmission, and delivers the modulated carrier signal to each of the receive antennas 40 and 41 through a matching network (not shown).

Various modulation and processing techniques available to those skilled in the art may be used for signal transmission between the mobile stations 16 and the base stations 14, either directly or via the relay stations 15.

OFDM Modulation

In OFDM modulation, the transmission band is divided into multiple, orthogonal carrier waves. Each carrier wave is modulated according to the digital data to be transmitted. Because OFDM divides the transmission band into multiple carriers, the bandwidth per carrier decreases and the modulation time per carrier increases. Since the multiple carriers are transmitted in parallel, the transmission rate for the digital data, or symbols, on any given carrier is lower than when a single carrier is used.

OFDM modulation includes the use of an Inverse Fast Fourier Transform (IFFT) on the information to be transmitted. For demodulation, a Fast Fourier Transform (FFT) is performed on the received signal to recover the transmitted information. In practice, the IFFT and FFT are provided by digital signal processing involving an Inverse Discrete Fourier Transform (IDFT) and Discrete Fourier Transform (DFT), respectively. Accordingly, a characterizing feature of OFDM modulation is that orthogonal carrier waves are generated for multiple bands within a transmission channel. The modulated signals are digital signals having a relatively low transmission rate and capable of staying within their respective bands. The individual carrier waves are not modulated directly by the digital signals. Instead, all carrier waves are modulated at once by IFFT processing.

In operation, OFDM is preferably used for at least downlink transmission from the base stations 14 to the mobile stations 16. Each of the base stations 14 is equipped with “n” of the transmit antennas (n>=1), and each of the mobile stations 16 is equipped with “m” of the receive antennas (m>=1). Notably, the respective antennas can be used for reception and transmission using appropriate duplexers or switches and are so labeled only for clarity.

When the relay stations 15 are used, OFDM is preferably used for downlink transmission from the base stations 14 to the relay stations and from the relay stations to the mobile stations 16.

Relay Station

With reference to FIG. 4, an exemplary relay station 15 is illustrated. Similarly to the base stations 14, and the mobile stations 16, the relay station 15 includes a control system 132, a baseband processor 134, transmit circuitry 136, receive circuitry 138, multiple antennas 130, and relay circuitry 142. The relay circuitry 142 enables the relay station 15 to assist in communications between one of the base stations 14 and one of the mobile stations 16. The receive circuitry 138 receives radio frequency signals bearing information from one or more of the base stations 14 and the mobile stations 16. A low noise amplifier and a filter (not shown) may cooperate to amplify and remove broadband interference from the signal for processing. Downconversion and digitization circuitry (not shown) will then downconvert the filtered, received signal to an intermediate or baseband frequency signal, which is then digitized into one or more digital streams.

The baseband processor 134 processes the digital streams to extract information or data bits conveyed in the signal. This processing typically comprises demodulation, decoding, and error correction operations. The baseband processor 134 is generally implemented in one or more digital signal processors (DSPs) and application specific integrated circuits (ASICs).

For transmission, the baseband processor 134 receives digitized data, which may represent voice, video, data, or control information, from the control system 132, which it encodes for transmission. The encoded data is output to the transmit circuitry 136, where it is used by a modulator to modulate one or more carrier signals at a desired transmit frequency or frequencies. A power amplifier (not shown) will amplify the modulated carrier signals to a level appropriate for transmission, and deliver the modulated carrier signal to the antennas 130 through a matching network (not shown). Various modulation and processing techniques available to those skilled in the art may be used for signal transmission between the mobile stations 16 and the base stations 14, either directly or indirectly via the relay stations 15, as described above.

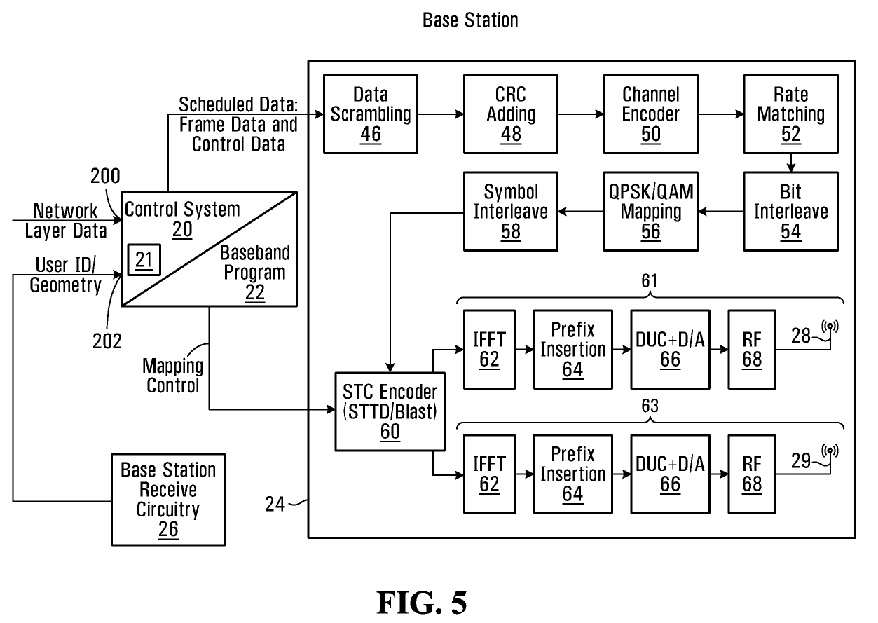

With reference to FIG. 5, a logical OFDM transmission architecture will be described. Referring to FIG. 1, initially, the base station controller 10 will send data to be transmitted to various ones of the mobile stations 16 to the base stations 14, either directly or with the assistance of one of the relay stations 15. The base stations 14 may use channel quality indicators (CQIs) associated with the mobile stations 16 to schedule the data for transmission and to select appropriate coding and modulation for transmitting the scheduled data. The CQls may be provided directly by the mobile stations 16 or may be determined by the base station 14 based on information provided by the mobile stations 16. In either case, the CQI for each mobile station 16 is a function of the degree to which the channel amplitude (or response) varies across the OFDM frequency band.

Transmitting Scheduled Data to Mobile Station

Referring to FIGS. 1 and 5, the scheduled data 44, is a stream of bits and this stream is scrambled in a manner reducing the peak-to-average power ratio associated with the data using data scrambling logic 46. A cyclic redundancy check (CRC) for the scrambled data is determined and appended to the scrambled data using CRC adding logic 48. Next, channel coding is performed using a channel encoder 50 to effectively add redundancy to the data to facilitate recovery and error correction at the mobile stations 16. The channel coding for a particular one of the mobile stations 16 is based on the CQI associated with the particular mobile station. In some implementations, the channel encoder 50 uses known Turbo encoding techniques. The encoded data is then processed by rate matching logic 52 to compensate for data expansion associated with encoding.

Bit interleaver logic 54 systematically reorders the bits in the encoded data to minimize loss of consecutive data bits. The re-ordered data bits are systematically mapped into corresponding symbols depending on the chosen baseband modulation by mapping logic 56. Preferably, Quadrature Amplitude Modulation (QAM) or Quadrature Phase Shift Key (QPSK) modulation is used. The degree of modulation is chosen based on the CQI associated with the particular mobile station. The symbols may be systematically reordered using symbol interleaver logic 58 to further bolster the immunity of the transmitted signal to periodic data loss caused by frequency selective fading.

At this point, groups of bits have been mapped into symbols representing locations in an amplitude and phase constellation. When spatial diversity is desired, blocks of symbols are then processed by space-time block code (STC) encoder logic 60, which modifies the symbols in a fashion making the transmitted signals more resistant to interference and more readily decoded at the mobile stations 16. The STC encoder logic 60 will process the incoming symbols and provide “n” outputs corresponding to the number of the transmit antennas (n=2 for the case shown in FIG. 5) for the base station 14. The control system 20 and/or the baseband processor 22 as described above with respect to FIG. 5 will provide a mapping control signal to control the STC encoder. At this point, assume the symbols for the “n” outputs are representative of the data to be transmitted and capable of being recovered by the mobile stations 16.

For the present example, assume the base station (14 in FIG. 1) has two of the transmit antennas 28 and 29 (n=2) and the STC encoder logic 60 provides two output streams of symbols. Each of the output streams of symbols is sent to a corresponding output path 61, 63, illustrated separately for ease of understanding. Those skilled in the art will recognize that one or more processors may be used to provide such digital signal processing, alone or in combination with other processing described herein. In each output path an IFFT processor 62 will operate on symbols provided to it to perform an inverse Fourier Transform. The output of the IFFT processor 62 provides symbols in the time domain. The time domain symbols also known as OFDM symbols are grouped into frames, by assigning a prefix by prefix insertion function 64. The resultant frame is up-converted in the digital domain to an intermediate frequency and converted to an analog signal via respective digital up-conversion (DUC) and digital-to-analog (D/A) conversion circuitry 66. The resultant (analog) signals from each output path are then simultaneously modulated at the desired RF frequency, amplified, and transmitted via RF circuitry 68 and the transmit antennas 28 and 29 to one of the mobile stations 16.

Referring to FIG. 14, a representation of an exemplary frequency spectrum transmitted by the antennas 28 and 29 is shown generally at 200. The spectrum 200 includes a plurality of spaced subcarriers, including a plurality of data carriers 202. Notably, the spectrum 200 also includes a plurality of pilot signals 204 scattered among the sub-carriers. The pilot signals 204 generally have a pre-determined pattern in both time and frequency that is known by the intended one of the mobile stations. In an OFDM transmission the pilot signal generally includes a pilot symbol. The mobile stations 16, which are discussed in detail below, will use the pilot signals for channel estimation.

Reception of Signals at the Mobile Station

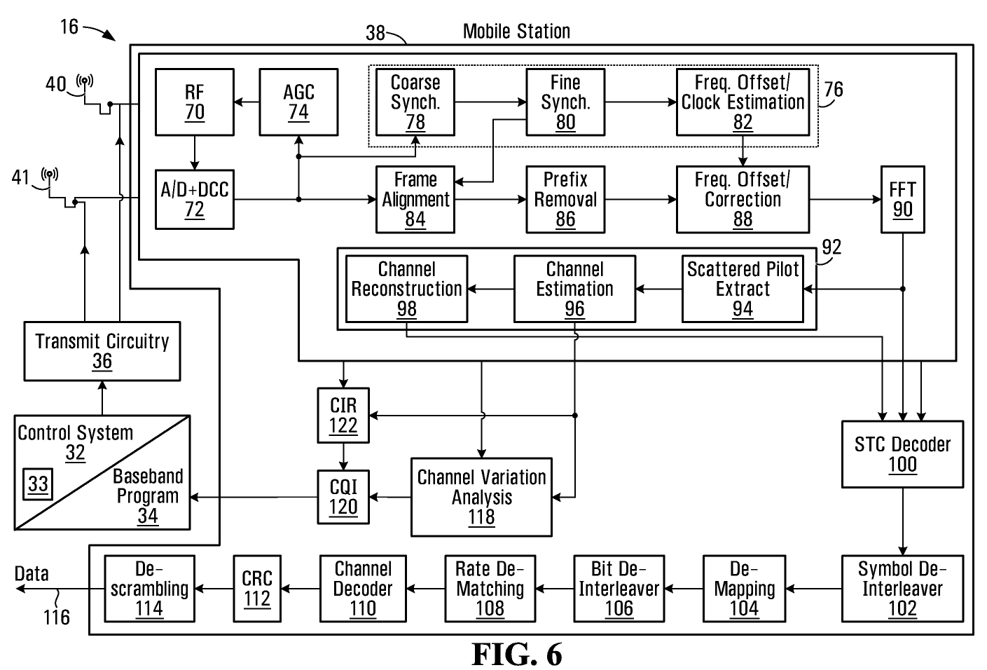

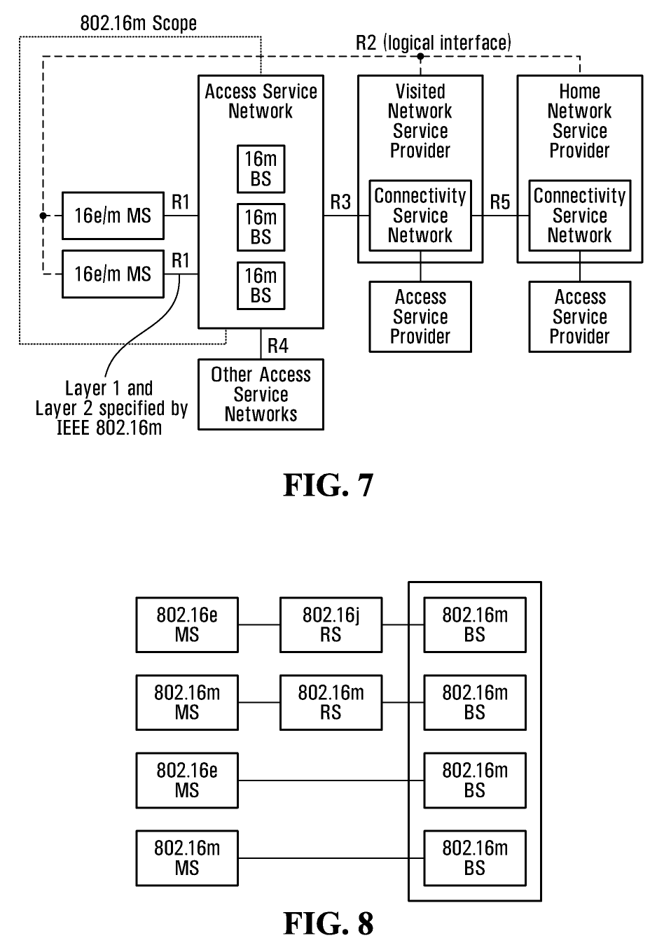

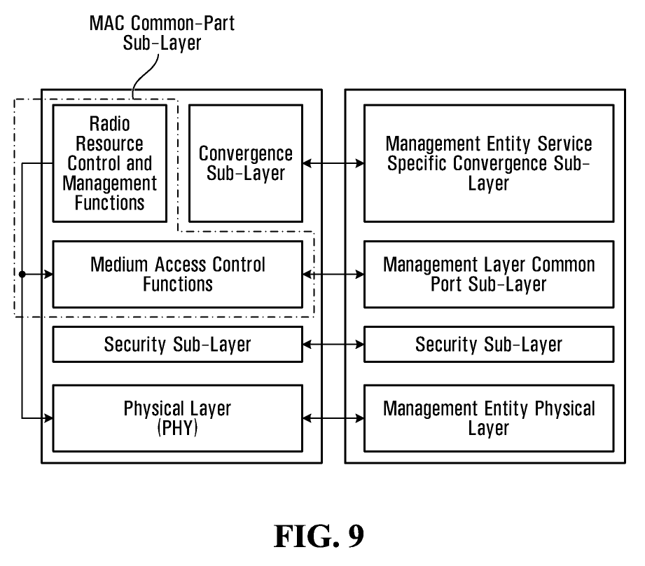

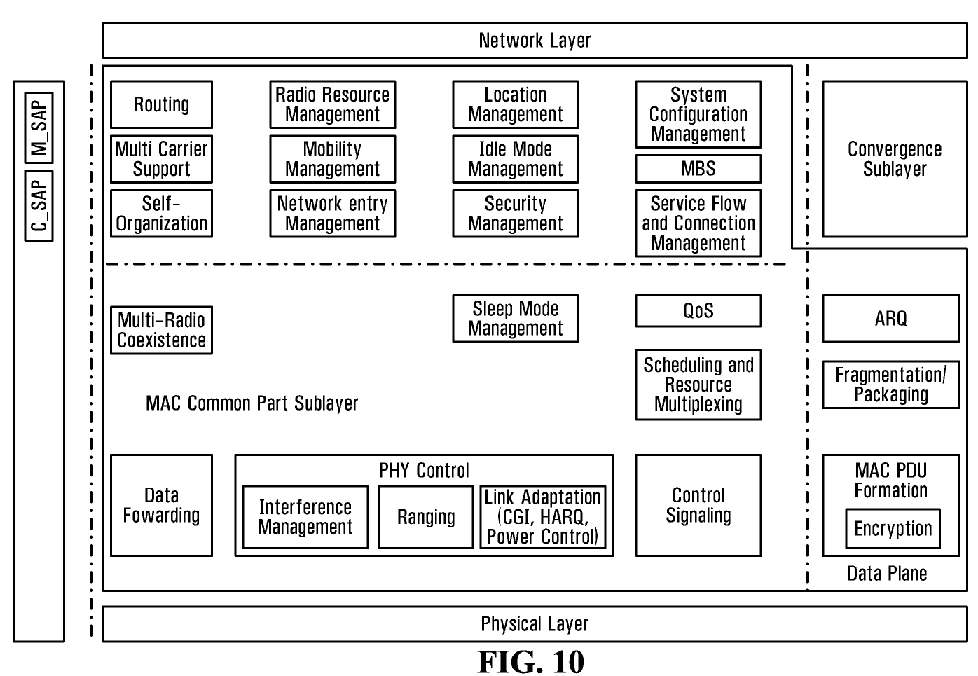

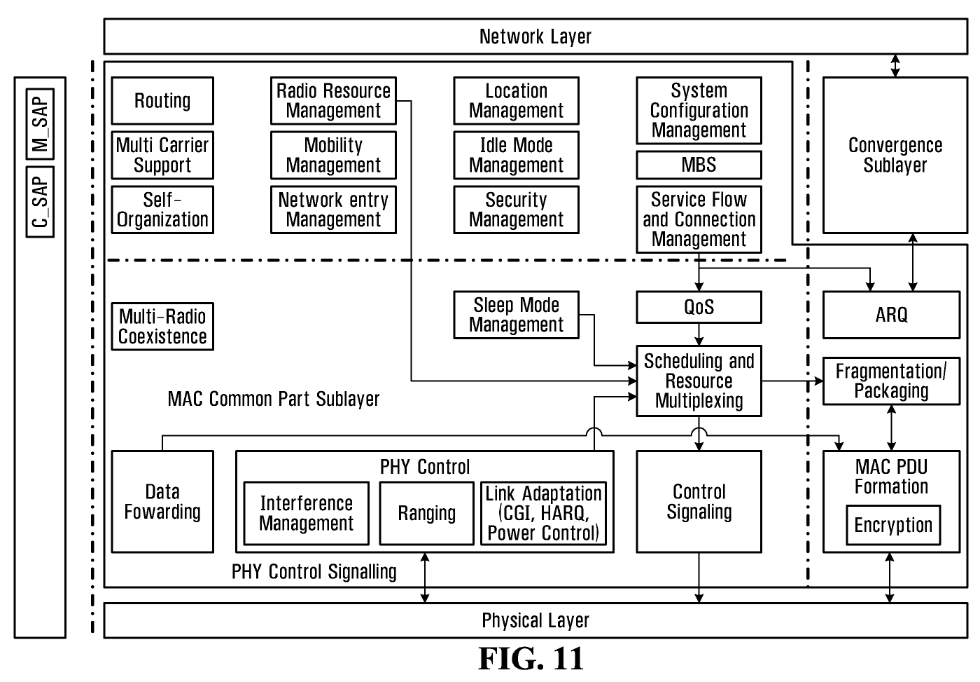

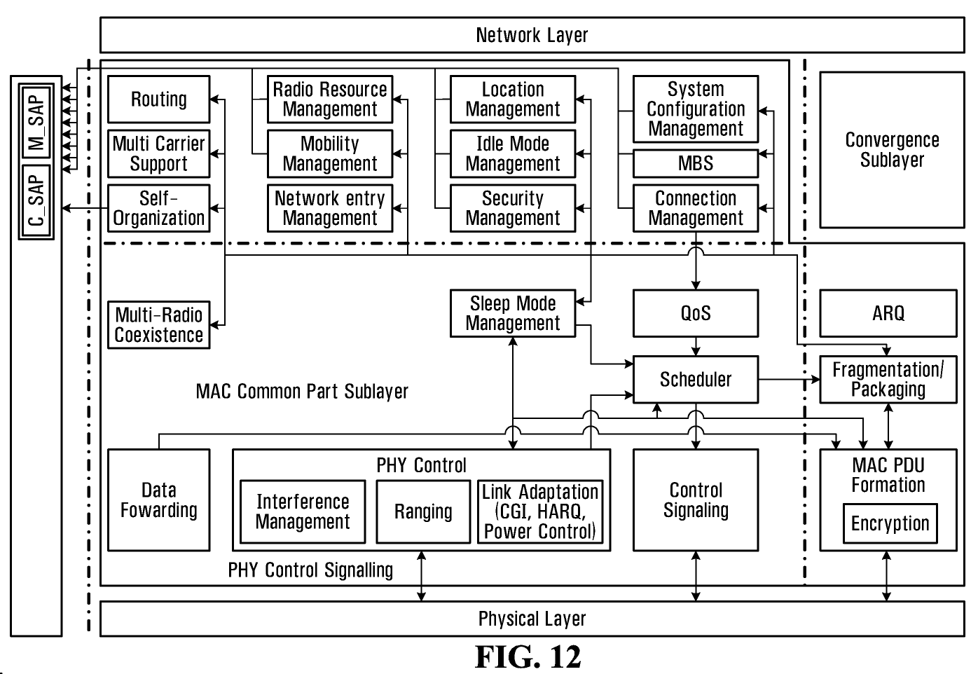

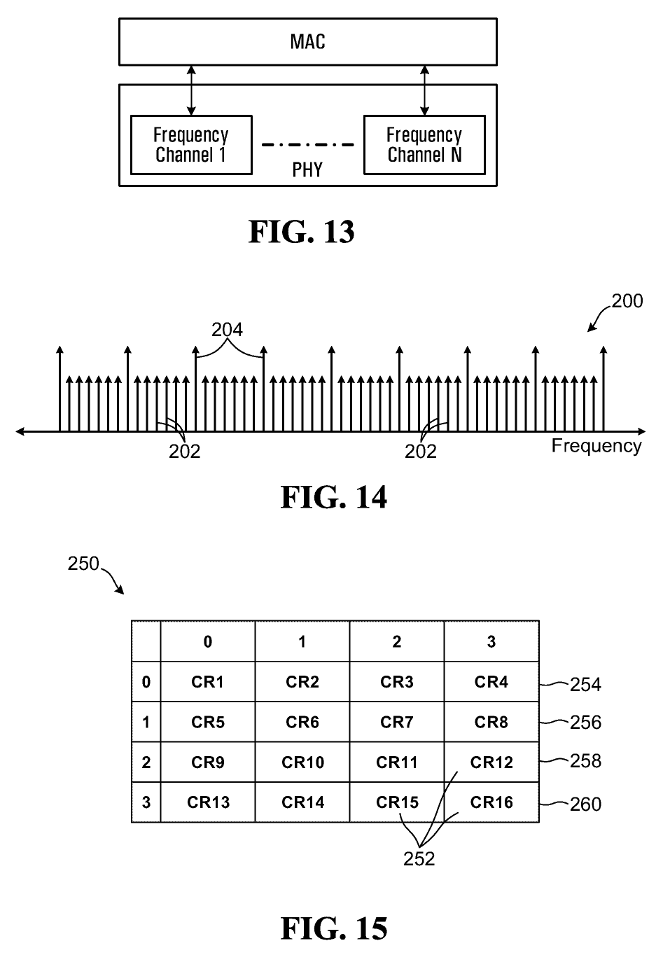

Reference is now made to FIG. 6 to illustrate reception of the transmitted signals by one of the mobile stations 16, either directly from one of the base stations (14 in FIG. 1) or with the assistance of one of the relay stations (15 in FIG. 1). Upon arrival of the transmitted signals at each of the receive antennas 40 and 41 of one of the mobile stations 16, the respective signals are demodulated and amplified by corresponding RF circuitry 70. For the sake of conciseness and clarity, only one of the two receive paths is described and illustrated in detail. Analog-to-digital (A/D) converter and down-conversion circuitry 72 digitizes and downconverts the analog signal for digital processing. The resultant digitized signal may be used by automatic gain control circuitry (AGC) 74 to control the gain of amplifiers in the RF circuitry 70 based on the received signal level.

Initially, the digitized signal is provided to synchronization logic shown generally at 76, which includes coarse synchronization function 78, which buffers several OFDM symbols and calculates an auto-correlation between the two successive OFDM symbols. A resultant time index corresponding to the maximum of the correlation result determines a fine synchronization search window, which is used by fine synchronization function 80 to determine a precise framing starting position based on the headers. The output of the fine synchronization function 80 facilitates frame acquisition by frame alignment logic 84. Proper framing alignment is important so that subsequent FFT processing provides an accurate conversion from the time domain to the frequency domain. The fine synchronization algorithm is based on the correlation between the received pilot signals carried by the headers and a local copy of the known pilot data. Once frame alignment acquisition occurs, the prefix of the OFDM symbol is removed with prefix removal logic 86 and resultant samples are sent to a frequency offset/correction function 88, which compensates for the system frequency offset caused by the unmatched local oscillators in a transmitter and a receiver. Preferably, the synchronization logic 76 includes a frequency offset and clock estimation function 82, which uses the headers to help estimate frequency offset and clock offset in the transmitted signal and provide those estimates to the frequency offset/correction function 88 to properly process OFDM symbols.

At this point, the OFDM symbols in the time domain are ready for conversion to the frequency domain by an FFT processing function 90. The result is a set of frequency domain symbols, which are sent to a processing function 92. The processing function 92 extracts the scattered pilot signals (shown in FIG. 14 at 204) using a scattered pilot extraction function 94, determines a channel estimate based on the extracted pilot signal using a channel estimation function 96, and provides channel responses for all sub-carriers using a channel reconstruction function 98. In one embodiment channel estimation involves using information in the pilot signal to generate a transfer function for the transmission channel between the base station 14 and the mobile station 16. The channel estimation function 96 may provide a matrix of values defining the channel response. As shown in FIG. 14, the pilot signal 204 is essentially multiple pilot symbols that are scattered among the data symbols throughout the OFDM sub-carriers in a known pattern in both time and frequency and facilitate determination of a channel response for each of the sub-carriers. The mobile station embodiment shown in FIG. 6 also includes a channel impulse response function 122, which facilitates estimation of the signal interference noise ratio (SINR) using the received signal and the SINR. In this embodiment a channel quality indicator (CQI) function 120 provides a channel quality indication, which includes the SINR determined by the CIR function 122 and may also include a receiver signal strength indicator (RSSI).

Continuing with FIG. 6, the processing logic compares the received pilot signals 204 with pilot signals that are expected in certain sub-carriers at certain times to determine a channel response for the sub-carriers in which pilot signals were transmitted. The results may be interpolated to estimate a channel response for most, if not all, of the remaining sub-carriers for which pilot signals were not provided. The actual and interpolated channel responses are used to estimate an overall channel response, which includes the channel responses for most, if not all, of the sub-carriers in the OFDM channel. Feedback of the channel response to the base station 14 is described in more detail below.

The frequency domain symbols and channel reconstruction information, which are derived from the channel responses for each receive path are provided to an STC decoder 100, which provides STC decoding on both received paths to recover the transmitted symbols. The channel reconstruction information provides equalization information to the STC decoder 100 sufficient to remove the effects of the transmission channel when processing the respective frequency domain symbols.

The recovered symbols are placed back in order using symbol de-interleaver logic 102, which corresponds to the symbol interleaver logic 58 of the transmitter. The de-interleaved symbols are then demodulated or de-mapped to a corresponding bitstream using de-mapping logic 104. The bits are then de-interleaved using bit de-interleaver logic 106, which corresponds to the bit interleaver logic 54 of the transmitter architecture. The de-interleaved bits are then processed by rate de-matching logic 108 and presented to channel decoder logic 110 to recover the initially scrambled data and the CRC checksum. Accordingly, CRC logic 112 removes the CRC checksum, checks the scrambled data in traditional fashion, and provides it to the de-scrambling logic 114 for de-scrambling using the known base station de-scrambling code to re-produce the originally transmitted data as data 116.

Still referring to FIG. 6, in parallel with recovering the data 116, a CQI, or at least information sufficient to create a CQI at each of the base stations 14, is determined and transmitted to each of the base stations. As noted above, the CQI may be a function of the carrier-to-interference ratio (CR), as well as the degree to which the channel response varies across the various sub-carriers in the OFDM frequency band. For this embodiment, the channel gain for each sub-carrier in the OFDM frequency band being used to transmit information is compared relative to one another to determine the degree to which the channel gain varies across the OFDM frequency band. Although numerous techniques are available to measure the degree of variation, one technique is to calculate the standard deviation of the channel gain for each sub-carrier throughout the OFDM frequency band being used to transmit data.

In some embodiments, the relay stations may operate in a time division manner using only one radio, or alternatively include multiple radios.

In the embodiments shown in FIG. 5 and FIG. 6, the mobile station 16 transmits using multiple antennas (28, 29) and the mobile station receives the transmission using multiple antennas, which is commonly referred to as a Multiple Input Multiple Output (MIMO) system. In other embodiments, the mobile station 16 may only have a single antenna (a Multiple Input Single Output (MISO) transmission system), or the base station and/or mobile station may use more than two antennas for transmitting and receiving signals.

Channel Response Feedback

In wireless communications between the base station 14 and the mobile station 16, knowledge of the channel response at base station facilitates changes to the coding of the symbols to make the transmitted signals more resistant to interference and more readily decoded at the mobile station. In the embodiment of the base station shown in FIG. 5, multiple antennas are utilized by the base station 14 for the transmission to the mobile station 16, and facilitate transmission of spatially diverse signals. Changes to the spatial diversity of the transmitted signals may be made by the base station 14 in response to receiving the channel response feedback from the mobile station 16. This is commonly referred to as closed-loop (CL) MIMO. Such changes to the spatial diversity may be communicated to the STC encoder logic 60 in a mapping control signal generated by the control system 20 and the baseband program logic 22. In one embodiment a precoding matrix is used to make changes to the spatial diversity of signals transmitted by changing the space-time coding of the symbols to be transmitted by the antennas 28 and 29 of the base station 14. The mapping control generated by the baseband processor 22 may include a precoding matrix indicator (PMI), which identifies a precoding matrix to be used by the STC encoder logic 60 for transmissions by the antennas 28 and 29.

Referring back to FIG. 6, a channel response produced by the channel estimation function 96 of the mobile station 16 will generally require many bits to represent and feedback each channel response, and thus would likely represent a significant transmission overhead. In order to reduce the transmission overhead, the channel response produced by the channel estimation function 96 for a particular set of sub-carriers or pilot signals may be compared to a plurality of predetermined channel responses in a table to select a representative predetermined channel response that is a closest match to the channel response. Such a table is commonly referred to as a codebook and the process of selecting the response may be referred to as quantization since the determined channel response is quantized to a predetermined channel response. Generally the codebook could be provided by downlink transmission from the base station 14 to the mobile station 16, and accordingly the codebook in use on the base station would match the codebook in use on the mobile station, thus facilitating feedback of an identifier to identify the selected quantized channel response. Alternatively, the codebook may be standardized and could be stored in the mobile station 16 at the time of manufacture. The base station 14 may then look in the locally stored codebook to determine the predetermined channel response that corresponds to the received identifier. As an example, a codebook having 16 predetermined channel responses may be represented by a 4-bit identifier defining the location of the predetermined channel response in the codebook. The identifier is commonly referred to as a codeword and is provided to the baseband processor 34 and control system 32 of the mobile station 16, which encodes the codeword for transmission by the transmit circuitry 36 to the base station 14 as part of an uplink data transmission.

Referring back to FIG. 5, the base station receive circuitry 26 of the base station 14 then receives the data transmission including the codeword, and the control system 20 extracts the codeword and generates any necessary changes to the mapping control signal provided to the STC encoder logic 60 for controlling subsequent transmissions to the mobile station over the antennas 28 and 29.

In order to achieve performance improvement, a codebook my require a large number of predetermined channel responses to reduce quantization errors when locating a closest match between the channel response produced by the channel estimation function 96 and the predetermined channel responses in the codebook. A large codebook size however increases the number of bits required for transmission of the codeword. For example, a codebook having 64 predetermined channel responses would require 6 bits for transmission of the codeword. Such codeword transmissions may occur at regular intervals and may end up occupying a significant fraction of uplink bandwidth.

Referring to FIG. 15, a codebook in accordance with one embodiment of the invention is shown in tabular form at 250. The codebook 250 includes a plurality of predetermined channel responses 252 (CR1-CR16). The predetermined channel responses 252 in the codebook are grouped in a plurality of clusters 254-260 in accordance with a correlation criterion. In the embodiment shown a first cluster 254 includes channel response members CR1-CR4, a second cluster 256 includes channel response members CR5-CR9, a third cluster 258 includes channel response members CR9-CR12, and a fourth cluster 260 includes channel response members CR13-CR16.

In one embodiment the channel response members placed in one of the clusters 254-260 share a common or primary feature or primary PMI. The primary PMI may provide an indication of a main component of the precoding matrix for cluster members and the channel response members in each cluster 254-260 define deviations from the primary PMI. Accordingly, the channel response members CR1-CR16 may define differences from the primary PMI referred to as differential PMI. Grouping differential PMIs in clusters 254-260 under a related primary PMI facilitates transmission of only a channel response member defining a differential PMI when there are small variations in the transmission channel, since the primary PMI still covers the channel response.

Referring back to FIG. 6, the mobile station control system 32 includes a processor circuit 33 that executes the above-described mobile station functions and in accordance with an embodiment of the invention executes certain additional functions for feedback of channel information characterizing the transmission between the base station 14 and the mobile station 16.

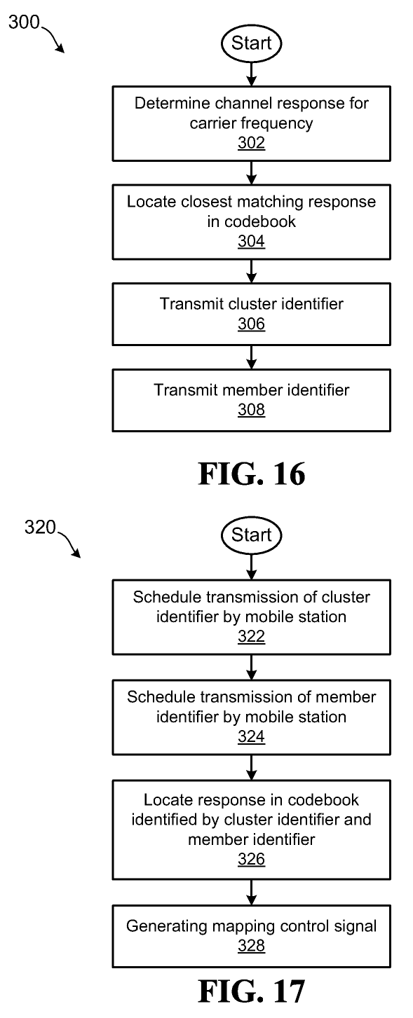

Referring to FIG. 16, in accordance with one embodiment of the invention, a process executed by the processor circuit 33 of a mobile station such as the mobile station 16 is shown as a flowchart generally at 300. The blocks in the flowchart generally represent codes that may be read from the computer readable medium, and stored in a program memory, for directing the processor circuit 33 to perform various functions related to feedback of a channel response. The actual code to implement each block may be written in any suitable program language.

The process 300 begins at block 302, which directs the processor circuit 33 to invoke the channel estimation function 96 (shown in FIG. 6) to determine a channel response for a carrier frequency received in a wireless transmission from the base station 14. In general for an OFDM transmission, a plurality of sub-carriers may be received and the channel response may only be determined for one or more of the pilot signals within the plurality of sub-carriers.

Block 304 then directs the processor circuit 33 to locate a predetermined channel response in the codebook 250 (shown in FIG. 15) that is a closest match to the determined channel response. Block 306 then directs the processor circuit 33 to cause the mobile station 16 to transmit a primary identifier identifying the cluster associated with the located predetermined channel response to the base station 14. For example, if the closest matching predetermined channel response is determined to be CR7 then the primary identifier may be “1” or digital “01” (2 bits). Block 308 then directs the processor circuit 33 to cause the mobile station 16 to transmit a differential identifier identifying the member of the cluster associated with the located predetermined channel response. In the above example, for CR7 the base station 14 would transmit “2” or digital “10” (2 bits).

In general, the primary identifier and differential identifier would be transmitted back to the base station 14 together with other data, such as voice, data, or control information. Such transmission of the primary identifier and differential identifier would be scheduled by the base station 14 by transmitting control information to the mobile station 16 to facilitate scheduling of the transmission.

Referring back to FIG. 5, the base station control system 20 includes a processor circuit 21 that executes the above-described base station functions and in accordance with an embodiment of the invention executes certain additional functions for scheduling and receiving feedback channel response information characterizing a transmission between the base station 14 and the mobile station 16.

Referring to FIG. 17, in accordance with one embodiment of the invention, a process executed by the processor circuit 21 of the base station 14 is shown as a flowchart generally at 320. The blocks in the flowchart generally represent codes that may be read from the computer readable medium, and stored in a program memory, for directing the processor circuit 21 to perform various functions related to receiving feedback of the channel response from the mobile station 16. The actual code to implement each block may be written in any suitable program language.

The process 320 begins at block 322, which directs the processor circuit 21 to receive a primary identifier identifying a cluster associated with a channel response generated by a mobile station. Block 324 then directs the processor circuit 21 to receive a differential identifier identifying channel response member within the cluster identified by the primary identifier. The process then continues at block 326, which directs the processor circuit 21 to locate a predetermined channel response identified by the primary identifier and the differential identifier in the codebook. Block 328 then directs the processor circuit 21 to generate the mapping control signal for controlling the STC encoder logic 60 for transmitting data to the mobile station.

In general terms, N₁ bits will be required to represent the primary identifier. For the codebook 250, N₁=2 bits, and there are 2^{N1}=2²=4 clusters. Similarly, N₂ bits will be required to represent the differential identifier. For the codebook 250, N₂=2 bits, and there are 2^{N2}=2²=4 members in each cluster. The codebook size is thus 2^{N}₁^{+N}₁⁾=2⁴=16 channel responses. For a codebook of the same size without grouping into clusters, the codeword length would be N₁+N₂=4 bits and thus 4 bits would have to be transmitted back to the base station 14 for each channel response. Advantageously, in the codebook embodiment shown where both the number of clusters and the number of members are the same, the primary identifier and the differential identifier each comprise 2-bits of data, which facilitates a unified uplink control channel design for the uplink transmission of the channel response. In other embodiments where the codebook has N1≠N2, the primary identifier may have a different number of bits to the differential identifier. Advantageously, the restructured codebook 250 permits channel response feedback to the base station 14 using only 2 bits for each channel response.

### EXAMPLE 1

In accordance with a first example, the base station 14 may schedule transmission of the primary identifier during a first transmission time period and may schedule transmission of the differential identifier during a second time period, where the second time period is subsequent to the first time period. The time periods may be in accordance with an uplink subframe data transmission rate between the mobile station 16 and the base station 14. In one embodiment, transmission of the primary identifier is scheduled periodically every T subframes (i.e. separated by a first predetermined time interval T). The mobile station 16, in response to the scheduling provided by the base station 14, invokes the channel estimation function 96 and searches over the clusters 254-260 in the codebook 250 (shown in FIG. 15) to determine which cluster best matches the channel response provided by the channel estimation function. The primary identifier corresponding to the selected cluster is then transmitted back to the base station 14 in accordance with the scheduling.

The differential identifier may be scheduled for periodic transmission for the remaining T-1 subframes between every T subframes. For example, primary identifier transmission may be scheduled for transmission every 10^{th} subframe and differential identifier transmission for the remaining 9 subframes. The mobile station 16, in response to the scheduling provided by the base station, invokes the channel estimation function 96 and then searches over the members in the previously selected cluster in the codebook 250 to determine which member in the cluster best matches the channel response provided by the channel estimation function. The differential identifier corresponding to the selected member in the cluster is then transmitted back to the base station 14 in accordance with the scheduling. This process for feedback of the differential identifier is periodically repeated until the next scheduled primary identifier transmission.

On receipt of the primary identifier and differential identifier, the base station 14 locates the corresponding predetermined channel response in a locally stored codebook copy by combining the primary identifier and the differential identifier, and generates a mapping control for controlling subsequent transmissions to the mobile station 16. The base station 14 would thus be able to determine which of the predetermined channel responses to use once the primary identifier and at least one differential identifier is received at the base station. Further differential identifiers received would be assumed to belong in the same cluster and may result in a different codebook entry being used for transmissions to the mobile station 16.

When changes in the transmission channel occur slowly enough, it may be assumed that the selected cluster identified by a primary identifier represents the channel response and thus it would only be necessary to transmit the differential identifier identifying differences within the selected cluster. In this embodiment, if a larger change in the transmission channel were to occur that necessitated a change to the selected cluster, an updated primary identifier selecting a new cluster would be transmitted by the mobile station at the next scheduled transmission of the primary identifier. Alternatively, if the base station 14 determines that a trend in received differential identifiers over a period of time is such that the channel may move to another cluster, the base station could request that the mobile station 16 send an updated primary identifier. Other channel quality indicators (CQI) may also be scheduled for transmission along with the cluster and differential identifiers.

Advantageously, by scheduling transmission of the primary identifier followed by the differential identifier, the uplink overhead for channel response feedback is reduced. Lower uplink overhead also translates into lower power usage by the mobile station 16 and increased resources to allocate to user data. Should any one of the differential identifiers not be received at the base station 14, the base station would be able to continue on the basis of the last received differential identifier, thus making the system somewhat robust to the loss of a channel feedback. Furthermore, the feedback is flexible for different MIMO modes in that it can be used for both Single user MIMO or Multiple User MIMO. Furthermore, in an embodiment where the primary identifier and differential identifier have the same number of bits, the scheduling of feedback is simplified as the same number of bits are transmitted during each subframe and the base station 14 simply interprets the bits on the basis of which identifier was scheduled for feedback in any particular subframe.

### EXAMPLE 2

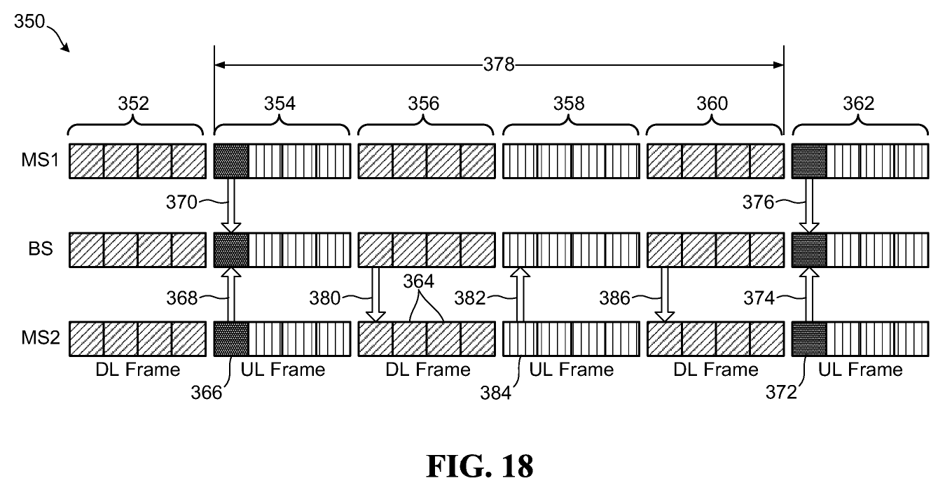

In accordance with a second example, the base station 14 may schedule periodic transmission of the primary identifier as described above in Example 1, while the differential identifier is only transmitted back to the base station 14 when requested by the base station. Referring to FIG. 18, exemplary transmissions between a base station (BS) and first and second mobile stations (MS1 and MS2) are shown schematically at 350. The data transmissions are shown as a plurality of alternating uplink (UL) frames 354, 358, 362 and downlink (DL) frames 352, 356, 360. Each downlink or uplink frame 352-362 comprises a plurality of subframes 364. Uplink frames are transmissions from the mobile station 16 to the base station 14, while downlink frames are transmissions from the base station to the mobile station.

At a first subframe 366 of the uplink frame 354, both MS1 and MS2 are scheduled by the base station to feed back a primary identifier as indicated by arrows 368 and 370. Similarly at a first subframe 372 of the uplink frame 362, both MS1 and MS2 are again scheduled by the base station to feed back a primary identifier as indicated by arrows 374 and 376. The primary identifier feedback thus occurs periodically every 16 subframes as indicated at 378.

In this example, feedback of the differential identifier is in response to a demand from the base station. In FIG. 18, the base station transmits a demand to the mobile station MS2 for feedback of a differential identifier at a first subframe of the downlink frame 356, as represented by the arrow 380. MS2 responds in the next uplink frame 358 by transmitting the differential identifier in data transmitted during a subframe 384, as indicated by arrow 382. In this example, no demand for feedback of a differential identifier is transmitted to the mobile station MS1, which may be in an idle state, for example. Transmission of other data, such as voice or control data continues between the base station and MS2 during the frame 360, as indicated by arrow 386. In the embodiment shown in FIG. 18, the demand transmitted by the base station 14 only requires feedback of a differential identifier in a single subframe 384 between transmissions of the primary identifier (i.e. during the time period 378). In another embodiment, if the base station determines that performance of the transmission channel is changing quickly, the base station may require more frequent transmission of differential identifiers between transmissions of the primary identifier and may even require that transmissions of the differential identifier occur at every subframe in the period 378. In one embodiment, the mobile station MS2 may also feed back a differential CQI.

Advantageously, on-demand feedback of the differential identifier reduces the overhead in the uplink (mobile station to base station) transmissions, which is a more limited resource. Since downlink bandwidth is larger than the uplink bandwidth, the demand placed on the base station may not be significant in comparison to the reduced uplink overhead. Mobile station MS1 incurs no additional uplink overhead other then the feedback of the primary identifier every 16 subframes. Lower uplink overhead also translates into lower power usage by the mobile stations MS1 and MS2. Furthermore, should one of the transmitted differential identifiers form a mobile station not be received at the base station, the demand could be re-transmitted by the base station while transmissions continue on the basis of the last received differential identifier, thus making the system somewhat robust to the loss of a differential identifier feedback.

### EXAMPLE 3

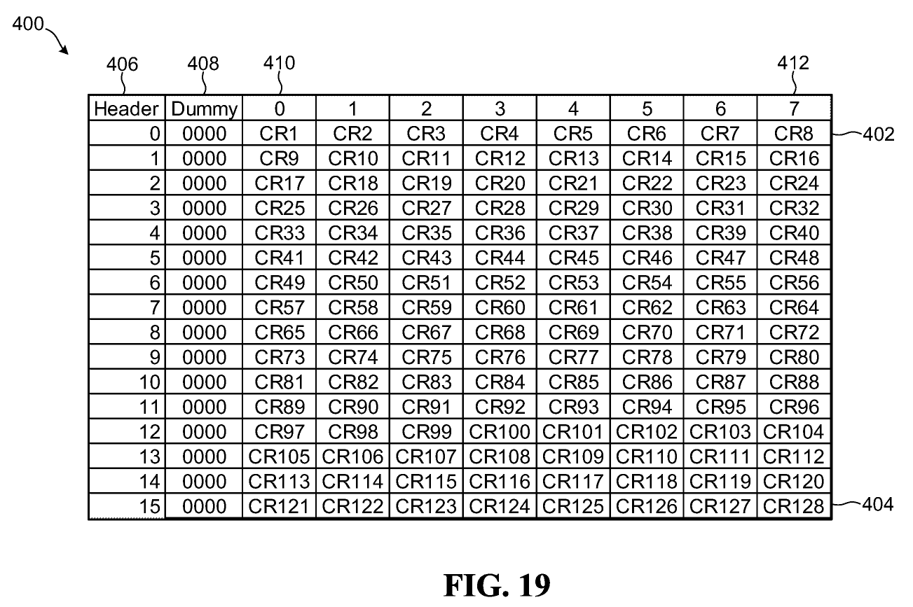

In accordance with a third example, aperiodic feedback of both a primary identifier and a differential identifier to the base station 14 is implemented using the codebook shown generally at 400 in FIG. 19. Referring to FIG. 19, the codebook includes 2^{N1}×2^{N2-1} channel responses, in this case CR1-CR128 for N1=4 and N2=4. The channel responses are grouped according to a correlation criterion into 2^{N1} clusters 402-404 (i.e. 16 clusters for N1=4). Each cluster includes a header 406, a dummy codeword 408, and 2^{N-2-1} channel response members 410 to 412. The headers 406 define the primary identifiers, while the indices 0-7 define the differential identifiers (codewords). The dummy codeword is used when the differential identifier identifying the channel response provided by the channel estimation function 96 no longer belongs to the cluster identified by the primary identifier.

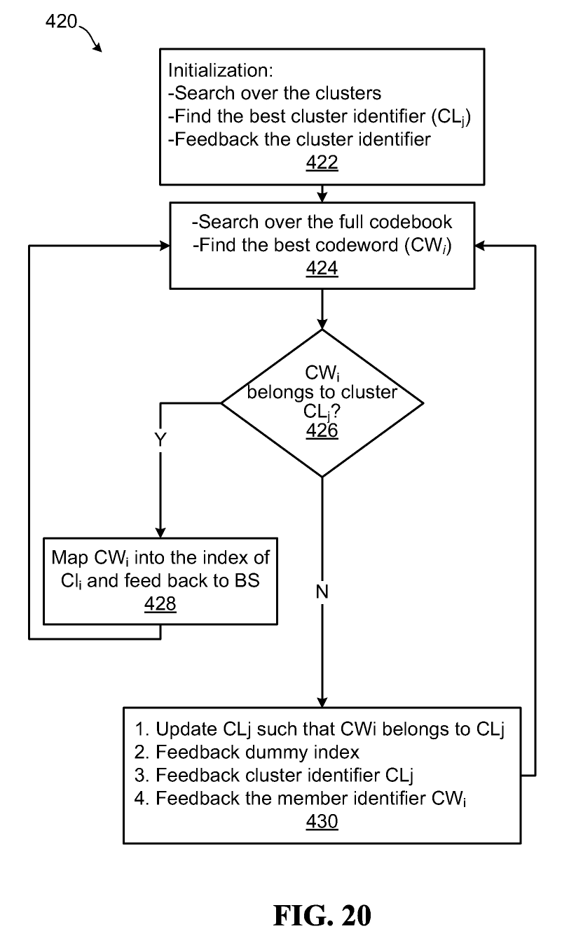

Referring to FIG. 20, a process for directing the mobile station 16 to determine the channel response codeword for aperiodic feedback of both the primary identifier and differential identifier to the base station 14 is shown generally at 420. The process begins at block 422, which directs the processor circuit 33 to initialize the process by searching over the codebook clusters 402-404 to find the closest matching cluster CLⱼ, which is transmitted to the base station 14. The process then continues at block 424, which directs the processor circuit 33 to search over the full codebook 400 to find the best channel response CWᵢ. Block 426 then directs the processor circuit 33 to determine whether the channel response found in block 424 belongs to the cluster found in block 422, in which case the process continues at block 428, which directs the processor circuit 33 to map the channel response CWᵢ into the index of the cluster CLⱼ and to feedback the response to the base station 14. The process then returns to block 424 and blocks 424 and 426 are repeated for the next channel response feedback.

If at block 426 the channel response found in block 424 does not belong to the cluster found in block 422, block 430 directs the processor circuit 33 to execute listed steps 1-4 in the block. In the first step, the primary identifier CLⱼ is updated such that the channel response member CWᵢ belongs to CLⱼ and a dummy index such as “000” is fed back to the base station. The dummy identifier provides an indication to the base station 14 that a primary identifier (rather than a differential identifier) will be sent on the next uplink transmission. This step is followed by feedback of the updated primary identifier CLⱼ and feedback of the differential identifier CWᵢ. Advantageously, in this example since the primary identifier is only transmitted when necessary, uplink overhead is reduced accordingly. When N1=N2 feedback of the primary identifier and differential identifier uses the same number of bits. Advantageously, while complexity at the mobile station is slightly higher due to the full search of the codebook for each channel response feedback rather than just the current cluster, the primary identifier is dynamically and aperiodically updated, thus reducing the uplink bandwidth while maintaining transmission performance.

Advantageously, the disclosed embodiments and examples facilitate a reduction in the transmission overhead associate with feedback of channel information characterizing the transmission channel between the base station and mobile station without reducing the number of channel response members in the codebook.

While specific embodiments of the invention have been described and illustrated, such embodiments should be considered illustrative of the invention only and not as limiting the invention as construed in accordance with the accompanying claims.

What is claimed is:

1. A method for feedback of channel information characterizing a wireless transmission between a base station and a mobile station over a communications channel, the method comprising:
receiving a primary identifier identifying a cluster associated with a channel response generated by a mobile station;
receiving a differential identifier identifying channel response member within the cluster identified by the primary identifier;
locating in a codebook of predetermined channel responses a predetermined channel response identified by said primary identifier and said differential identifier, the predetermined channel responses in the codebook being grouped in a plurality of clusters in accordance with a correlation criterion, each cluster including a plurality of predetermined channel response members; and
generating a control signal for controlling transmissions to the mobile station in accordance with said located predetermined channel response.

2. The method of claim 1 wherein receiving said primary identifier comprises causing the mobile station to transmit said primary identifier during a first time period and wherein receiving the differential identifier comprises causing the mobile station to transmit said differential identifier during a second time period, said second time period occurring subsequent to said first time period.

3. The method of claim 2 wherein causing the mobile station to transmit said primary identifier during said first time period comprises causing the mobile station to transmit said differential identifier at a plurality of first time periods separated in time by a first predetermined time interval.

4. The method of claim 3 wherein causing the mobile station to transmit said differential identifier comprises causing the mobile station to transmit a differential identifier at a plurality of second time periods separated in time by a second predetermined time interval, said second predetermined time interval being less than said first predetermined time interval.

5. The method of claim 4 wherein causing the mobile station to transmit said differential identifier comprises causing the mobile station to transmit said differential identifier during a plurality of second time periods separated in time by a predetermined time interval between successive first time periods.

6. The method of claim 2 wherein causing the mobile station to transmit said differential identifier comprises causing the mobile station to transmit said differential identifier when a criterion for transmission of said differential identifier is met.

7. The method of claim 1 wherein said codebook comprises N1 clusters, each cluster comprising N2 members and wherein causing the mobile station to transmit said primary identifier and said differential identifier comprises causing the mobile station to transmit a primary identifier and a differential identifier having the same number of bits.

8. The method of claim 1 further comprising periodically transmitting said codebook to the mobile station.

9. The method of claim 8 wherein each cluster in said codebook is associated with a primary predetermined channel response and wherein each member in the cluster defines respective differences from the associated primary predetermined channel response.

10. A method for feedback of channel information characterizing a wireless transmission between a base station and a mobile station over a communications channel, the method comprising:
determining a channel response for at least one carrier frequency received at the mobile station;
locating in a codebook of predetermined channel responses a predetermined channel response that is a closest match to the determined channel response, the predetermined channel responses in the codebook being grouped in a plurality of clusters in accordance with a correlation criterion, each cluster including a plurality of predetermined channel response members;
causing the mobile station to transmit a primary identifier identifying a cluster associated with the located predetermined channel response to the base station; and
causing the mobile station to transmit a differential identifier identifying the located predetermined channel response member within the cluster identified by the primary identifier.

11. The method of claim 10 wherein said determining comprises determining said channel response during successive time periods and wherein said locating comprises for each successive time period, locating a predetermined channel response that is a closest match to the determined channel response and wherein:
causing the mobile station to transmit said primary identifier comprises causing the mobile station to transmit said primary identifier during a first time period; and
causing the mobile station to transmit said differential identifier comprises causing the mobile station to transmit said differential identifier during a second time period, said second time period occurring subsequent to said first time period.

12. The method of claim 11 wherein causing the mobile station to transmit said primary identifier comprises causing the mobile station to transmit said differential identifier at a plurality of first time periods separated in time by a first predetermined time interval.

13. The method of claim 12 wherein causing the mobile station to transmit said differential identifier comprises causing the mobile station to transmit a differential identifier at a plurality of second time periods separated in time by a second predetermined time interval, said second predetermined time interval being less than said first predetermined time interval.

14. The method of claim 13 wherein causing the mobile station to transmit said differential identifier comprises causing the mobile station to transmit said differential identifier during a plurality of second time periods separated in time by a predetermined time interval between successive first time periods.

15. The method of claim 11 wherein causing the mobile station to transmit said differential identifier comprises causing the mobile station to transmit said differential identifier when a criterion for transmission of said differential identifier is met.

16. The method of claim 15 wherein said criterion for transmission of said differential identifier comprises a demand from the base station.

17. The method of claim 15 wherein said criterion for transmission of said differential identifier comprises a determination made by the base station.

18. The method of claim 11 further comprising causing the mobile station to transmit a new primary identifier to said base station when a predetermined channel response that is the closest match to the determined channel response is not associated with said cluster identified by said primary identifier transmitted to the base station in a previous first time period.

19. The method of claim 10 wherein said codebook comprises N1 clusters, each cluster comprising N2 members and wherein causing the mobile station to transmit said primary identifier and said differential identifier comprises causing the mobile station to transmit a primary identifier and a differential identifier having the same number of bits.

20. The method of claim 10 further comprising periodically causing said mobile station to receive said codebook from the base station.

21. The method of claim 20 wherein each cluster is associated with a primary predetermined channel response and wherein each member in the cluster defines respective differences from the associated primary predetermined channel response.

22. A base station apparatus comprising:
a receiver for receiving a wireless transmission from a mobile station over a communications channel;
a processor circuit in communication with said receiver, said processor circuit having a computer readable medium for storing a codebook of predetermined channel responses grouped in a plurality of clusters in accordance with a correlation criterion, each cluster including a plurality of predetermined channel response members, the processor circuit being operably configured to:
receive a primary identifier identifying a cluster associated with a channel response generated by a mobile station; and
receive a differential identifier identifying channel response member within the cluster identified by the primary identifier;
locate in said codebook a predetermined channel response identified by said cluster and said differential identifier; and
generate a control signal for controlling transmissions to the mobile station in accordance with said located predetermined channel response.

23. A mobile station apparatus comprising:
a receiver for receiving a wireless transmission from a base station over a communications channel;
a processor circuit in communication with said receiver, said processor circuit having a computer readable medium for storing a codebook of predetermined channel responses grouped in a plurality of clusters in accordance with a correlation criterion, each cluster including a plurality of predetermined channel response members, the processor circuit being operably configured to:
determine a channel response for at least one carrier frequency received at said receiver;
locate in said codebook a predetermined channel response that is a closest match to the determined channel response;
transmit a primary identifier identifying a cluster associated with the located predetermined channel response to the base station; and
transmit a differential identifier identifying the located predetermined channel response member within the cluster identified by the primary identifier.
